(19) United States
(12) Patent Application Publication
(10) Pub. No.: US 2026/0176446 A1
(43) Pub. Date: Jun. 25, 2026

(54) METAL SULFIDE AND USE THEREOF, AND RESIN COMPOSITION CONTAINING THE SAME

(71) Applicant: GUANGDONG XINDA ADVANCED MATERIALS TECHNOLOGY CO., LTD., HEYUAN (CN)

(72) Inventors: ZEPENG LIN, HEYUAN (CN); JUN LIN, HEYUAN (CN); HUAXIONG LIN, HEYUAN (CN)

(21) Appl. No.: 19/538,924

(22) Filed: Feb. 12, 2026

Related U.S. Application Data
(63) Continuation of application No. PCT/CN2024/075278, filed on Feb. 1, 2024.

(51) Int. Cl. C08K 5/098; H01M 4/62

(52) U.S. Cl. CPC C08K 5/098; H01M 4/62

(57) ABSTRACT

The present application discloses a metal sulfide and use thereof, and a resin composition containing the metal sulfide, and relates to the technical field of sulfides. The metal sulfide of the present application is a zinc sulfide material, and the zinc sulfide material has a particle size distribution satisfying the following relationships: 1.0≤1000× (Dv75−Dv25)/(Dv50)²≤2.2 and 3.0≤(Dv97×Dv50)/(Dv10×1000)≤12.8; where the Dv10, Dv25, Dv50, Dv75, and Dv97 represent particle diameters corresponding to cumulative volume distribution percentages of 10%, 25%, 50%, 75%, and 97% of the zinc sulfide material, respectively, all expressed in nm. The particle size distribution of the metal sulfide is controlled, so that the resin composition containing the metal sulfide exhibits high color stability and a low whiteness variation rate under alternating high- and low-temperature environments.

### TECHNICAL FIELD

The present application relates to the technical field of sulfides, and specifically, to a metal sulfide and use thereof, and a resin composition containing the metal sulfide.

### BACKGROUND

Zinc sulfide (ZnS), as a white pigment, has a high refractive index and opacity, is easily dispersed and not prone to agglomeration, and, when applied in plastics and coatings, can provide materials with good hiding power and whitening effect.

In general, resin materials containing zinc sulfide exhibit good color stability. However, as plastic products are increasingly used in outdoor applications, such as housings for outdoor electronic devices, building door and window profiles, outdoor plastic chairs, and garden fences, more stringent requirements are imposed on the color stability of the materials.

For example, in recent years, with the development of the LED industry, there has been a growing demand for high-power, high-brightness LED packages. In the prior art, it is reported that the materials tend to exhibit yellowing under prolonged high-temperature irradiation when LED components use a polymer resin as a matrix and zinc sulfide as a white pigment. Therefore, for high-power, high-brightness LED components, such as housings and reflective supports, the materials are required not only to have suitable whiteness but also to exhibit good color stability.

In addition, for some usage scenarios in which the environment is more severe, such as an environment with alternating high and low temperatures, resin materials containing zinc sulfide often exhibit more pronounced whiteness variation.

Therefore, to further expand the application range of zinc sulfide materials, and particularly to meet the requirements of severe high- and low-temperature environments, it is necessary to provide a zinc sulfide material with minimal whiteness variation under such severe conditions.

### SUMMARY

To overcome the deficiencies in the prior art, an objective of the present application is to provide a metal sulfide and use thereof, and a resin composition containing the metal sulfide. The particle size distribution of the zinc sulfide material is controlled, so that the resin composition containing the zinc sulfide material exhibits high color stability and a low whiteness variation rate under alternating high- and low-temperature environments.

To achieve the foregoing objective, according to a first aspect, the present application provides a metal sulfide, where the metal sulfide is a zinc sulfide material, the zinc sulfide material has a particle size distribution of Dv25, Dv50, and Dv75, satisfying the following relationship: 1.0≤1000× (Dv75−Dv25)/(Dv50)²≤2.2, and
the zinc sulfide material has a particle size distribution of Dv10, Dv50, and Dv97, satisfying the following relationship: 3.0≤(Dv97×Dv50)/(Dv10×1000)≤12.8;
where the Dv10, Dv25, Dv50, Dv75, and Dv97 represent particle diameters corresponding to cumulative volume distribution percentages of 10%, 25%, 50%, 75%, and 97% of the zinc sulfide material, respectively, all expressed in nm.

In a preferred embodiment of the present application, the zinc sulfide material has a particle size distribution of Dv25, Dv50, and Dv75, satisfying the following relationship:

$$1.1 \leq 1000 \times ( Dv 75 - Dv 25 ) / {( Dv 50 )}^{2} \leq 2.0 .$$

In a preferred embodiment of the present application, the zinc sulfide material has a particle size distribution of Dv10, Dv50, and Dv97, satisfying the following relationship:

$$3.5 \leq ( Dv 97 \times Dv 50 ) / ( Dv 10 \times 1000 ) \leq 12.0 .$$

In a preferred embodiment of the present application, the Dv50 of the zinc sulfide material is 550-850 nm.

In a more preferred embodiment of the present application, the Dv50 of the zinc sulfide material is 630-780 nm.

In a preferred embodiment of the present application, the zinc sulfide material satisfies at least one of the following features (a)-(d):
(a) the Dv10 of the zinc sulfide material is 200-340 nm;
(b) the Dv25 of the zinc sulfide material is 350-500 nm;
(c) the Dv75 of the zinc sulfide material is 900-1500 nm; or
(d) the Dv97 of the zinc sulfide material is 1600-4500 nm.

In a more preferred embodiment of the present application, the zinc sulfide material satisfies at least one of the following features (e)-(h):
(e) the Dv10 of the zinc sulfide material is 250-300 nm;
(f) the Dv25 of the zinc sulfide material is 380-480 nm;
(g) the Dv75 of the zinc sulfide material is 1000-1400 nm; or
(h) the Dv97 of the zinc sulfide material is 3200-4300 nm.

In a preferred embodiment of the present application, the zinc sulfide material has a particle size distribution of Dv50 and a bulk density (BD), satisfying the following relationship:

$$18 \leq Dv 50 / ( lgBD \times 10 ) \leq 27 ;$$

where the Dv50 is expressed in nm, and the BD is expressed in kg/m³.

In a preferred embodiment of the present application, the BD of the zinc sulfide material is 600-1200 kg/m³.

In a preferred embodiment of the present application, the zinc sulfide material has a bulk density (BD) and a tapped density (TD), satisfying the following relationship:

$$( T D - B D ) / T D * 100 \% \leq 40 \% ;$$

where the TD and the BD are both expressed in kg/m³.

In a preferred embodiment of the present application, the BD of the zinc sulfide material is 900-1500 kg/m³.

In a preferred embodiment of the present application, the zinc sulfide material has a specific surface area as measured by the Brunauer-Emmet-Teller (BET) method of 8.5-11.5 m²/g.

According to a second aspect, the present application provides use of the metal sulfide in preparation of a resin composition.

According to a third aspect, the present application provides a resin composition, which includes the following components in parts by weight:
100 parts of resin, and 0.5-10 parts of the metal sulfide.

In a preferred embodiment of the present application, the resin includes at least one of polyethylene (PE), polypropylene (PP), polyamide (PA), polycarbonate (PC), poly(butylene terephthalate) (PBT), poly(ethylene terephthalate) (PET), epoxy resin (EP), acrylonitrile-butadiene-styrene (ABS) copolymer, or styrene-acrylonitrile (AS) copolymer.

The present application has the following beneficial effects.

The metal sulfide of the present application has an appropriate particle size distribution, such that a resin composition containing the metal sulfide exhibits high color stability and a low whiteness variation rate under alternating high- and low-temperature environments.

### DETAILED DESCRIPTION OF THE EMBODIMENTS

To make the objectives, technical solutions, and beneficial effects of the embodiments of the present application clearer, the technical solutions in the embodiments of the present application are described below in a clear and complete manner. It is apparent that the described embodiments are some but not all of embodiments of the present application. All other embodiments obtained by those of ordinary skill in the art based on embodiments of the present application without creative efforts shall fall within the protection scope of the present application.

In the present application, for the technical features described in an open-ended manner, both closed technical solutions composed of the listed features and open-ended technical solutions including the listed features are encompassed.

In the present application, with respect to numerical ranges, unless otherwise specified, the ranges are considered continuous and include both the minimum and maximum values of the range, as well as every value between the minimum and maximum. Further, when the ranges refer to integers, every integer between the minimum and maximum values of the range is included. In addition, when a plurality of range-describing features or properties are provided, the ranges can be combined. In other words, unless otherwise indicated, all ranges disclosed herein are to be understood as including any and all sub-ranges encompassed therein.

In the present application, the dispersion or stirring treatment methods are not particularly limited.

The reagents or instruments used in the present application, for which the manufacturer is not specified, are conventional products that can be obtained commercially.

To solve the problem of color changes in a resin composition containing zinc sulfide under alternating high- and low-temperature environments in the prior art,
an embodiment of the present application provides a metal sulfide, where the metal sulfide is a zinc sulfide material, the zinc sulfide material has a particle size distribution of Dv25, Dv50, and Dv75, satisfying the following relationship: 1.0≤1000× (Dv75−Dv25)/(Dv50)²≤2.2, and
the zinc sulfide material has a particle size distribution of Dv10, Dv50, and Dv97, satisfying the following relationship: 3.0≤(Dv97×Dv50)/(Dv10×1000)≤12.8;
where the Dv10, Dv25, Dv50, Dv75, and Dv97 represent particle diameters corresponding to cumulative volume distribution percentages of 10%, 25%, 50%, 75%, and 97% of the zinc sulfide material, respectively, all expressed in nm.

Studies of the present application have found that when the Dv10, Dv25, Dv50, Dv75, and Dv97 of the zinc sulfide material satisfy the foregoing two relationships by controlling the particle size distribution of zinc sulfide, the zinc sulfide material can not only effectively provide hiding power in the resin, but also has an appropriate particle size distribution, resulting in a more uniform and stable dispersion state of the zinc sulfide material in the resin. The zinc sulfide material exhibits a high interfacial bonding strength between the inorganic zinc sulfide and the organic resin. Under severe temperature conditions, the zinc sulfide material of the present application exhibits superior stability, which is not prone to decomposition or degradation to generate colored substances, does not undergo adverse reactions or interactions with other components in the resin, and does not reduce the whitening or hiding power of the resin due to volatilization. In addition, the incorporation of the zinc sulfide material of the present application into a resin composition greatly improves the stability of the resin composition, making the material less susceptible to color changes caused by environmental temperature variations, thereby improving the color stability of a resin composition containing the zinc sulfide material.

In the relationship 1.0≤1000× (Dv75−Dv25)/(Dv50)²≤2.2, a smaller value of (Dv75−Dv25) indicates a relatively narrower particle size distribution of the zinc sulfide material. However, when the value of (Dv75−Dv25) is too small, the particle sizes of the zinc sulfide material are overly uniform, which prevents a combination of large and small particles, and limits the improvement in color stability of a resin composition containing the zinc sulfide material. In addition, the ratio of 1000×(Dv75−Dv25) to (Dv50)² should be within the range of 1.0-2.2, where the Dv50 represents the median particle size of the zinc sulfide material. When (Dv50)² is too large or too small, causing 1000×(Dv75−Dv25)/(Dv50)² to be less than 1.0 or greater than 2.2, the zinc sulfide material may exhibit severe inter-particle cohesion, poor dispersibility, reduced hiding power, or decreased stability, thereby leading to unsatisfactory color stability of a resin composition containing the zinc sulfide material and a high whiteness variation rate under alternating high- and low-temperature aging conditions.

In the relationship 3.0≤(Dv97×Dv50)/(Dv10×1000)≤12.8, the Dv97 represents the particle size corresponding to a cumulative volume distribution percentage of 97% of the zinc sulfide material, which corresponds to the average particle size of relatively large particles. Similarly, the Dv10 represents the average particle size of relatively small particles. The ratio of (Dv97×Dv50) to (Dv10×1000) is controlled within 3.0-12.8, such that an appropriate difference between particle sizes of the zinc sulfide material is achieved, thereby significantly enhancing the interfacial bonding strength between the inorganic zinc sulfide material and the organic resin, and avoiding color stability reduction caused by phase separation in a resin composition containing the zinc sulfide material under severe temperature conditions.

The methods for measuring Dv10, Dv25, Dv50, Dv75, and Dv97 are not limited in the present application. Those skilled in the art can determine the particle size distribution of the zinc sulfide material using conventional techniques. For example, reference can be made to GB/T 19077-2016: Particle size analysis—Laser diffraction methods, and a laser particle size analyzer can be used, such as the LS-POP (9) laser particle size analyzer from Omec.

In an embodiment, the zinc sulfide material has a particle size distribution of Dv25, Dv50, and Dv75, satisfying the following relationship: 1.1≤1000× (Dv75−Dv25)/(Dv50)²≤2.0.

In an embodiment, the zinc sulfide material has a particle size distribution of Dv10, Dv50, and Dv97, satisfying the following relationship: 3.5≤(Dv97×Dv50)/(Dv10×1000)≤12.0.

Studies of the present application have found that when the particle size distribution of the zinc sulfide material further satisfies the foregoing range of relationships, a resin composition containing the zinc sulfide material exhibits improved color stability and a lower whiteness variation rate after alternating high- and low-temperature treatment.

In an embodiment, the Dv50 of the zinc sulfide material is 550-850 nm. For example, the Dv50 of the zinc sulfide material may be 605 nm, 632 nm, 680 nm, 750 nm, 772 nm, 800 nm, or 837 nm.

In a preferred embodiment, the Dv50 of the zinc sulfide material is 630-780 nm.

In a preferred embodiment, the zinc sulfide material satisfies at least one of the following features (a)-(d):
(a) the Dv10 of the zinc sulfide material is 200-340 nm;
(b) the Dv25 of the zinc sulfide material is 350-500 nm;
(c) the Dv75 of the zinc sulfide material is 900-1500 nm; or
(d) the Dv97 of the zinc sulfide material is 1600-4500 nm.

In a preferred embodiment, the Dv10 of the zinc sulfide material is 250-300 nm. For example, the Dv10 of the zinc sulfide material may be 265 nm, 270 nm, 272 nm, or 278 nm.

In a preferred embodiment, the Dv25 of the zinc sulfide material is 380-480 nm. For example, the Dv25 of the zinc sulfide material may be 408 nm, 415 nm, 420 nm, 430 nm, or 446 nm.

In a preferred embodiment, the Dv75 of the zinc sulfide material is 1000-1400 nm. For example, the Dv75 of the zinc sulfide material may be 1085 nm, 1150 nm, 1220 nm, 1350 nm, or 1400 nm.

In a preferred embodiment, the Dv97 of the zinc sulfide material is 3200-4300 nm. For example, the Dv97 of the zinc sulfide material may be 3400 nm, 3500 nm, 3700 nm, 3950 nm, 4000 nm, 4150 nm, or 4260 nm.

In an embodiment, the zinc sulfide material has a particle size distribution of Dv50 and a bulk density (BD), satisfying the following relationship: 18≤Dv50/(lgBD×10)≤27;
where the Dv50 is expressed in nm, and the BD is expressed in kg/m³.

The bulk density (BD) reflects the inter-particle void volume of the zinc sulfide material and also, to a certain extent, indicates the particle morphology of the zinc sulfide material. When the zinc sulfide material satisfies the relationship Dv50/(lgBD×10)=18-27, the particle size distribution of the zinc sulfide material is moderate, the particle morphology of the zinc sulfide material is appropriate, and the inter-particle void volume is moderate, thereby contributing to improved color stability of a resin composition containing the zinc sulfide material.

In an embodiment, the BD of the zinc sulfide material is 650-1200 kg/m³. For example, the BD of the zinc sulfide material may be 660 kg/m³, 670 kg/m³, 680 kg/m³, 700 kg/m³, 900 kg/m³, or 1150 kg/m³.

In a preferred embodiment, the BD of the zinc sulfide material is 660-800 kg/m³.

In an embodiment, the zinc sulfide material has a bulk density (BD) and a tapped density (TD), satisfying the following relationship: (TD−BD)/TD*100%≤40%;
where the TD and the BD are both expressed in kg/m³.

In a preferred embodiment, the zinc sulfide material has a bulk density (BD) and a tapped density (TD), satisfying the following relationship: 20≤(TD−BD)/TD*100%≤35%.

The ratio of (TD−BD) to TD corresponds to a compressibility of the zinc sulfide material. The compressibility of the zinc sulfide material is correlated with the morphological regularity degree and particle size distribution of zinc sulfide particles. When (TD−BD)/TD*100% falls within the foregoing preferred range, the zinc sulfide material provides a more favorable improvement effect on color stability.

In an embodiment, the TD of the zinc sulfide material is 900-1500 kg/m³. For example, the TD of the zinc sulfide material may be 950 kg/m³, 970 kg/m³, 1000 kg/m³, 1050 kg/m³, 1100 kg/m³, 1200 kg/m³, or 1420 kg/m³.

In a preferred embodiment, the TD of the zinc sulfide material is 950-1150 kg/m³.

The methods for measuring the bulk density (BD) and the tapped density (TD) of the zinc sulfide material are not limited in the present application. Those skilled in the art can determine the BD and TD of the zinc sulfide material using conventional techniques. Exemplary methods include the following: the zinc sulfide material is allowed to fall naturally into a 100 cm³ stainless steel cylindrical container through a vibrating sample supply device until the container is filled with the zinc sulfide material. Excess zinc sulfide material on the container is removed using a blade. The measured density, converted to the unit of kg/m³, corresponds to the bulk density of the zinc sulfide material. Next, a lid is placed on the 100 cm³ stainless steel cylindrical container. The zinc sulfide material is allowed to flow into the container through a vibrating sample supply device. The material is subjected to compaction under the conditions of a stroke length (tapped height) of 18 mm, a tapping speed of 60 times/minute, and a tapping number of 180. Excess zinc sulfide material on the container is removed using a blade. The measured density, converted to the unit of kg/m³, corresponds to the tapped density of the zinc sulfide material.

An embodiment of the present application provides use of the metal sulfide in preparation of a resin composition.

An embodiment of the present application provides a resin composition, which includes the following components in parts by weight:
100 parts of resin, and 0.5-10 parts of the metal sulfide.

In an embodiment, the resin includes at least one of polyethylene (PE), polypropylene (PP), polyamide (PA), polycarbonate (PC), poly(butylene terephthalate) (PBT), poly(ethylene terephthalate) (PET), epoxy resin (EP), acrylonitrile-butadiene-styrene (ABS) copolymer, or styrene-acrylonitrile (AS) copolymer.

In practical applications, based on actual performance requirements, the resin composition may further include 0-10 parts by weight of other additives. The other additives are selected from at least one of lubricants, yellowing inhibitors, antioxidants, heat stabilizers, light stabilizers, other polymers, impact modifiers, flame retardants, optical brighteners, plasticizers, thickeners, antistatic agents, release agents, or nucleating agents.

It should be noted that the preparation method of the resin composition is not particularly limited in the present application. Those skilled in the art can prepare the resin composition using conventional techniques.

For example, the preparation method of the resin composition includes the following steps:
mixing the resin, the metal sulfide, and other additives, adding the mixture to an extruder, and performing melt mixing and extrusion to produce the resin composition.

Specifically, the extruder can be a twin-screw extruder, where the length-diameter ratio of screws of the twin-screw extruder is 36-72:1, the rotating speed of the screws is 100-500 rpm, and the melting temperature of the twin-screw extruder is 180-280° C.

After testing under alternating high- and low-temperature aging conditions, the whiteness variation rate of the resin composition is ≤10%. The specific conditions of the alternating high- and low-temperature aging test are as follows: the resin composition is injection-molded into a specimen with a thickness of 2 cm and placed in a high- and low-temperature test chamber. The test conditions include a low temperature of −10±2° C. maintained for 12 h, followed by a high temperature of 80±3° C. maintained for 12 h, with a temperature transition time of less than 30 s, constituting one cycle; a total of 10 cycles are performed.

The present application is further illustrated by the following specific examples:

### EXAMPLES AND COMPARATIVE EXAMPLES

Examples and comparative examples of the present application each prepare a zinc sulfide material. The preparation of the zinc sulfide material includes the following steps:
grinding zinc oxide into a powder and dispersing the powder into a 20 wt. % sulfuric acid solution, with the system pH controlled at 5-7;
adding sodium sulfide, where the weight ratio of sodium sulfide to zinc oxide is 1:(2-2.5), and reacting under conditions of 80-120° C. and stirring at 100-200 rpm for 15-18 h, with the reaction system pH controlled at 6-8;
after completion of the reaction, cooling and separating the product, washing the product three times with distilled water, followed by filtration, drying, grinding, and sieving; and obtaining zinc sulfide materials with different particle size distributions, bulk densities, and tapped densities by controlling the grinding degree and the sieving conditions.

Specifically, the particle size distributions, bulk densities, and tapped densities of the zinc sulfide materials of Examples 1-9 and Comparative Examples 1-3 are shown in Table 1.

TABLE 1

| | Dv10 | Dv25 | Dv50 | Dv75 | Dv97 | BD | TD |
|---|---|---|---|---|---|---|---|
| | (nm) | (nm) | (nm) | (nm) | (nm) | (kg/m³) | (kg/m³) |
| Example 1 | 272 | 408 | 632 | 1085 | 3401 | 680 | 1050 |
| Example 2 | 278 | 446 | 772 | 1408 | 4260 | 800 | 1200 |
| Example 3 | 295 | 438 | 640 | 922 | 1628 | 920 | 1390 |
| Example 4 | 318 | 461 | 687 | 1046 | 4333 | 850 | 1100 |
| Example 5 | 328 | 421 | 592 | 1193 | 1781 | 720 | 980 |
| Example 6 | 235 | 360 | 552 | 1020 | 3110 | 820 | 1090 |
| Example 7 | 286 | 467 | 847 | 1188 | 4196 | 850 | 1100 |
| Example 8 | 270 | 411 | 635 | 1089 | 3380 | 750 | 1280 |
| Example 9 | 337 | 476 | 834 | 1487 | 4253 | 600 | 850 |
| Comparative | 295 | 379 | 595 | 1485 | 4290 | 730 | 1120 |
| Example 1 | | | | | | | |
| Comparative | 259 | 476 | 830 | 1090 | 4474 | 780 | 1190 |
| Example 2 | | | | | | | |
| Comparative | 334 | 388 | 565 | 1280 | 1661 | 770 | 1060 |
| Example 3 | | | | | | | |

After calculation, the formulas satisfied by each of examples and comparative examples are shown in Table 2.

The zinc sulfide materials prepared in each of examples and comparative examples were used as white pigments. A resin composition was prepared according to the following component amounts (parts by weight): 100 parts of polyamide resin, 3 parts of white pigment, and 1 part of antioxidant 1010.

The resin composition was prepared according to the following steps:
the polyamide resin, white pigment (zinc sulfide material), and antioxidant 1010 were mixed and fed into a twin-screw extruder; the screw rotation speed of the twin-screw extruder was set at 300 rpm, and the melt temperature was set at 260° C.; and after melt mixing and extrusion, the resin composition was obtained.

The color stability of the resin composition was tested, and the results are shown in Table 2. The specific testing method was as follows:
the resin composition was injection-molded into a specimen with a thickness of 2 cm, the initial whiteness value (W1) was measured, and the specimen was then subjected to alternating high- and low-temperature aging tests. The conditions of the alternating high- and low-temperature aging tests were as follows: the injection-molded specimen was placed in a high- and low-temperature test chamber, with a low temperature of −10±2° C. maintained for 12 h, followed by a high temperature of 80±3° C. maintained for 12 h, the temperature transition time was less than 30 s, constituting one cycle, and a total of 10 cycles were performed. After aging, the whiteness value (W2) of the specimen was measured again, and the whiteness variation rate (ΔW) was calculated as ΔW=(W1−W2)/W1*100%;

The whiteness value was measured as follows:
the chromaticity of the specimen was determined using a spectrophotometer SD5000 (Nippon Denshoku Industries Co., Ltd., Japan), and the brightness (L), red value (a), and yellow value (b) were calculated according to the Hunter color difference formula. The whiteness (W) was then calculated according to the following equation: W=100−[(100−L)²+a²+b²]^{1/2}.

TABLE 2

| | | (Dv97 × | | | |
|---|---|---|---|---|---|
| | 1000 × | Dv50)/ | Dv50/ | (TD − | |
| | (Dv75 − | (Dv10 × | (lgBD × | BD)/ | |
| | Dv25)/Dv50² | 1000) | 10) | TD*100% | ΔW |
| Example 1 | 1.69 | 7.90 | 22.3 | 35% | 6.6% |
| Example 2 | 1.61 | 11.83 | 26.6 | 33% | 6.8% |
| Example 3 | 1.18 | 3.53 | 21.6 | 34% | 7.1% |
| Example 4 | 1.24 | 9.36 | 23.5 | 23% | 7.3% |
| Example 5 | 2.20 | 3.21 | 20.7 | 27% | 9.7% |
| Example 6 | 2.17 | 7.31 | 18.9 | 25% | 9.3% |
| Example 7 | 1.01 | 12.43 | 28.9 | 23% | 9.5% |
| Example 8 | 1.68 | 7.95 | 22.1 | 41% | 8.9% |
| Example 9 | 1.45 | 10.53 | 30.0 | 29% | 8.7% |
| Comparative | 3.12 | 8.65 | 20.8 | 35% | 18.5% |
| Example 1 | | | | | |
| Comparative | 0.89 | 14.34 | 28.7 | 34% | 21.2% |
| Example 2 | | | | | |
| Comparative | 2.79 | 2.81 | 19.6 | 27% | 27.3% |
| Example 3 | | | | | |

As shown in Table 2, the zinc sulfide materials of the examples of the present application effectively improved the color stability of the resin compositions. Under the alternating high- and low-temperature aging conditions, the whiteness variation rate of the resin compositions containing the zinc sulfide materials of the examples was less than 10%.

According to the test results of Examples 1-4 and Examples 5-7, when the particle size distribution of the zinc sulfide materials further satisfies 1.1≤1000× (Dv75−Dv25)/(Dv50)²≤2.0 and 3.5≤(Dv97×Dv50)/(Dv10×1000)≤12.0, the color stability of the resin compositions containing the zinc sulfide materials is further improved, and the whiteness variation rate of the resin compositions after alternating high- and low-temperature treatment is smaller.

According to the results of Examples 1˜4 and Examples 8-9, when the zinc sulfide materials further satisfy 18≤Dv50/(lgBD×10)≤27 and (TD−BD)/TD*100%≤40%, the improvement in the whiteness stability of the resin compositions is more significant, and the whiteness variation rate of the resin compositions is relatively lower.

It should be noted that although only the polyamide resin is used as the resin component of the resin composition in the examples of the present application, practically, comparable color stability effects can be achieved when the polyamide resin is replaced with other thermoplastic or thermosetting resins, such as polyethylene, polypropylene, polycarbonate, poly(butylene terephthalate), poly(ethylene terephthalate), epoxy resin, acrylonitrile-butadiene-styrene copolymer, or styrene-acrylonitrile copolymer.

In addition, when the zinc sulfide material of Example 1 is used as the white pigment and the resin composition is prepared with a composition of 100 parts polyamide resin, 10 parts white pigment, and 1 part antioxidant 1010, the whiteness variation rate of the resin composition is 5.1%. When the zinc sulfide material of Example 1 is used as the white pigment and the resin composition is prepared with a composition of 100 parts polyamide resin, 0.1 parts white pigment, and 1 part antioxidant 1010, the whiteness variation rate of the resin composition is 8.9%.

Finally, it should be noted that the above examples are provided merely to illustrate the technical solutions of the present application and do not limit the scope of protection of the present application. Although the present application has been described in detail with reference to the preferred examples, those of ordinary skill in the art should understand that modifications or equivalent substitutions can be made to the technical solutions of the present application without departing from the spirit and scope of the present application.

What is claimed is:

1. A metal sulfide, wherein the metal sulfide is a zinc sulfide material, the zinc sulfide material has a particle size distribution of Dv25, Dv50, and Dv75, satisfying the following relationship: 1.0≤1000×(Dv75−Dv25)/(Dv50)²≤2.2, and
the zinc sulfide material has a particle size distribution of Dv10, Dv50, and Dv97, satisfying the following relationship: 3.0≤(Dv97×Dv50)/(Dv10×1000)≤12.8;
wherein the Dv10, Dv25, Dv50, Dv75, and Dv97 represent particle diameters corresponding to cumulative volume distribution percentages of 10%, 25%, 50%, 75%, and 97% of the zinc sulfide material, respectively, all expressed in nm.

2. The metal sulfide according to claim 1, wherein the zinc sulfide material has a particle size distribution of Dv25, Dv50, and Dv75, satisfying the following relationship:
$$1.1 \leq 1000 \times ( Dv 75 - Dv 25 ) / {( Dv 50 )}^{2} \leq 2.0 .$$

3. The metal sulfide according to claim 1, wherein the zinc sulfide material has a particle size distribution of Dv10, Dv50, and Dv97, satisfying the following relationship:
$$3.5 \leq ( Dv 97 \times Dv 50 ) / ( Dv 10 \times 1000 ) \leq 12.0 .$$

4. The metal sulfide according to claim 3, wherein the Dv50 of the zinc sulfide material is 550-850 nm.

5. The metal sulfide according to claim 3, comprising at least one of the following features (a)-(d):
(a) the Dv10 of the zinc sulfide material is 200-340 nm;
(b) the Dv25 of the zinc sulfide material is 350-500 nm;
(c) the Dv75 of the zinc sulfide material is 900-1500 nm; or
(d) the Dv97 of the zinc sulfide material is 1600-4500 nm.

6. The metal sulfide according to claim 1, wherein the zinc sulfide material has a particle size distribution of Dv50 and a bulk density (BD), satisfying the following relationship:
$$18 \leq Dv 50 / ( lgBD \times 10 ) \leq 27 ;$$
wherein the Dv50 is expressed in nm, and the BD is expressed in kg/m³.

7. The metal sulfide according to claim 6, wherein the BD of the zinc sulfide material is 600-1200 kg/m³.

8. The metal sulfide according to claim 7, wherein the zinc sulfide material has a bulk density (BD) and a tapped density (TD), satisfying the following relationship:
$$( T D - B D ) / T D * 100 \% \leq 40 \% ;$$
wherein the TD and the BD are both expressed in kg/m³.

9. The metal sulfide according to claim 8, wherein the TD of the zinc sulfide material is 900-1500 kg/m³.

10. Use of the metal sulfide according to claim 9 in preparation of a resin composition.

11. A resin composition, comprising the following components in parts by weight:
100 parts of resin, and 0.5-10 parts of metal sulfide;
wherein the metal sulfide is a zinc sulfide material, the zinc sulfide material has a particle size distribution of Dv25, Dv50, and Dv75, satisfying the following relationship:
$$1. \leq 1000 \times ( Dv 75 - Dv 25 ) / {( Dv 50 )}^{2} \leq 2.2 ,$$
the zinc sulfide material has a particle size distribution of Dv10, Dv50, and Dv97, satisfying the following relationship: 3.0≤(Dv97×Dv50)/(Dv10×1000)≤12.8;
wherein the Dv10, Dv25, Dv50, Dv75, and Dv97 represent particle diameters corresponding to cumulative volume distribution percentages of 10%, 25%, 50%, 75%, and 97% of the zinc sulfide material, respectively, all expressed in nm.

12. The resin composition according to claim 11, wherein the metal sulfide is a zinc sulfide material, the zinc sulfide material has a particle size distribution of Dv25, Dv50, and Dv75, satisfying the following relationship: 1.0≤1000× (Dv75−Dv25)/(Dv50)²≤2.2, and
the zinc sulfide material has a particle size distribution of Dv10, Dv50, and Dv97, satisfying the following relationship: 3.0≤(Dv97×Dv50)/(Dv10×1000)≤12.8;
wherein the Dv10, Dv25, Dv50, Dv75, and Dv97 represent particle diameters corresponding to cumulative volume distribution percentages of 10%, 25%, 50%, 75%, and 97% of the zinc sulfide material, respectively, all expressed in nm.

13. The resin composition according to claim 11, wherein the zinc sulfide material has a particle size distribution of Dv25, Dv50, and Dv75, satisfying the following relationship:
$$1.1 \leq 1000 \times ( Dv 75 - Dv 25 ) / {( Dv 50 )}^{2} \leq 2.0 .$$

14. The resin composition according to claim 13, wherein the zinc sulfide material has a particle size distribution of Dv10, Dv50, and Dv97, satisfying the following relationship: 3.5≤(Dv97×Dv50)/(Dv10×1000)≤12.0.

15. The resin composition according to claim 13, wherein the Dv50 of the zinc sulfide material is 550-850 nm.

16. The resin composition according to claim 11, comprising at least one of the following features (a)-(d):
(a) the Dv10 of the zinc sulfide material is 200-340 nm;
(b) the Dv25 of the zinc sulfide material is 350-500 nm;
(c) the Dv75 of the zinc sulfide material is 900-1500 nm; or
(d) the Dv97 of the zinc sulfide material is 1600-4500 nm.

17. The resin composition according to claim 16, wherein the zinc sulfide material has a particle size distribution of Dv50 and a bulk density (BD), satisfying the following relationship:
$$18 \leq Dv 50 / ( lgBD \times 10 ) \leq 27 ;$$
wherein the Dv50 is expressed in nm, and the BD is expressed in kg/m³.

18. The resin composition according to claim 17, wherein the BD of the zinc sulfide material is 600-1200 kg/m³.

19. The resin composition according to claim 18, wherein the zinc sulfide material has a bulk density (BD) and a tapped density (TD), satisfying the following relationship:
$$( T D - B D ) / T D * 100 \% \leq 40 \% ;$$
wherein the TD and the BD are both expressed in kg/m³.

20. The resin composition according to claim 11, wherein the resin comprises at least one of polyethylene, polypropylene, polyamide, polycarbonate, poly (butylene terephthalate), poly (ethylene terephthalate), epoxy resin, acrylonitrile-butadiene-styrene copolymer, or styrene-acrylonitrile copolymer.
